(19) United States
(12) Patent Application Publication
(10) Pub. No.: US 2026/0098319 A1
(43) Pub. Date: Apr. 9, 2026

(54) METHOD OF RECYCLING BATTERY

(71) Applicant: TOYOTA JIDOSHA KABUSHIKI KAISHA, Toyota-shi (JP)

(72) Inventor: Tomohiro YOKOYAMA, Toyota-shi (JP)

(73) Assignee: TOYOTA JIDOSHA KABUSHIKI KAISHA, Toyota-shi (JP)

(21) Appl. No.: 19/273,760

(22) Filed: Jul. 18, 2025

(30) Foreign Application Priority Data
Oct. 4, 2024 (JP) 2024-175328

(51) Int. Cl. C22B 7/00; C22B 3/22; H01M 10/54

(52) U.S. Cl. CPC C22B 7/007; C22B 3/22; H01M 10/54

(57) ABSTRACT

A method of recycling a battery includes: performing acid extraction by using a black mass obtained after the battery is dismantled; performing filtering and washing, the filtering including filtering a dissolved matter and an undissolved component obtained by the acid extraction; and mixing a black mass residue that is an insoluble component obtained by the filtering and washing into crude oil. The method does not include adjusting a ph before the filtering and washing.

### CROSS-REFERENCE TO RELATED APPLICATION

This application claims priority to Japanese Patent Application No. 2024-175328 filed on Oct. 4, 2024. The disclosure of the above-identified application, including the specification, drawings, and claims, is incorporated by reference herein in its entirety.

### BACKGROUND

### 1. Technical Field

The present disclosure relates to a method of recycling a battery.

### 2. Description of Related Art

Japanese Unexamined Patent Application Publication No. 2024-054072 (JP 2024-054072 A) discloses, as a method of recycling a battery, causing a black mass of a lithium-ion battery to react with an oxidizing gas to extract lithium from the black mass.

### SUMMARY

However, in the configuration described in JP 2024-054072 A, a large number of members out of components of the battery are discarded without being recycled, and there is room for improvement in recycling efficiency of the battery.

The present disclosure has been made in view of the above-mentioned circumstances, and has an object to provide a method of recycling a battery that can improve the recycling efficiency of the battery.

The present disclosure provides a method of recycling a battery, the method including: performing acid extraction by using a black mass obtained after the battery is dismantled; performing filtering and washing, the filtering including filtering a dissolved matter and an undissolved component obtained by the acid extraction; and mixing a black mass residue that is an insoluble component obtained by the filtering and washing into crude oil, in which the method does not include adjusting a ph before the filtering and washing.

In the present disclosure, the recycling efficiency of the battery can be improved.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a flowchart illustrating a method of recycling a battery in an embodiment;

FIG. 2 is an explanatory flowchart illustrating the method of recycling the battery in the embodiment in more detail; and

FIG. 3 is a flowchart illustrating a method of recycling a battery in a comparative example.

### DETAILED DESCRIPTION OF EMBODIMENTS

Hereinafter, a method of recycling a battery in an embodiment of the present disclosure is specifically described. It is to be noted that the present disclosure is not limited to the embodiment described below.

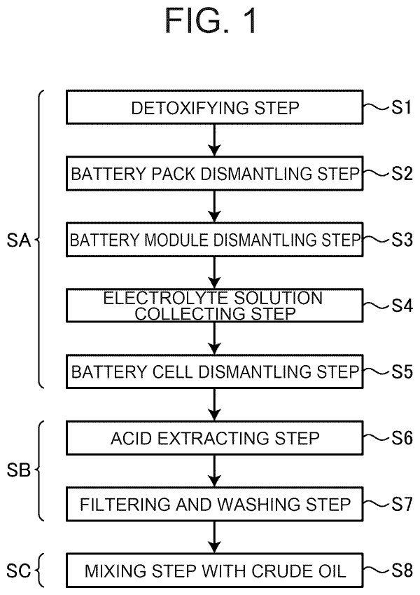

FIG. 1 is a flowchart illustrating a method of recycling a battery in an embodiment. The method of recycling the battery is a method of recycling a lithium-ion battery. The method of recycling the battery in the embodiment is a method of recycling a lithium-ion battery, and is a method of recycling, as valuables, a black mass residue obtained after metal components in an active material are removed by acid extraction or the like. That is, the method of recycling the battery in the embodiment is a method of material-recycling a carbon-rich insoluble component (a black mass residue) that is not eluted by acid extraction or the like. In the black mass residue, pure carbon components such as graphite or acetylene black included in a negative electrode active material and a positive electrode electrically conductive auxiliary agent occupy the most part.

The lithium-ion battery to be recycled is a battery pack including a battery module including a plurality of battery cells. Examples of the battery pack include a battery pack including rectangular battery cells, and a bipolar type lithium-ion battery. The bipolar type lithium-ion battery has a structure in which a plurality of bipolar electrodes is stacked. The bipolar electrodes each include a positive electrode provided on one surface of a current collector and a negative electrode provided on the other surface of the current collector.

The method of recycling the battery includes a detoxifying step (step S1), a battery pack dismantling step (step S2), a battery module dismantling step (step S3), an electrolyte solution collecting step (step S4), a battery cell dismantling step (step S5), an acid extracting step (step S6), a filtering and washing step (step S7), and a mixing step with crude oil (step S8).

The detoxifying step is a step of detoxifying the battery pack to allow safe treatment of the battery pack (step S1). The detoxifying step includes a step of discharging the battery pack. The battery pack is a bipolar type lithium-ion battery including a bipolar electrode.

The battery pack dismantling step is a step of dismantling the battery pack to separate the battery module from components of the battery pack (step S2). The battery pack includes a plurality of battery modules, and the battery modules each include the bipolar electrode.

The battery module dismantling step is a step of dismantling the battery module and canceling the restriction to dismantle the battery module into units of battery cells (step S3). In this dismantling step, from the battery module formed into a quadrilateral shape, resins on four sides such as seal materials are removed.

The electrolyte solution collecting step is a step of opening a can in a hermetically sealed state, and removing the electrolyte solution to achieve detoxication (step S4). The collecting step is a non-roasting step. In this collecting step, the electrolyte solution that is a combustible material is removed.

The battery cell dismantling step is a step of breaking down the battery cell to perform physical separation into each component (step S5). This dismantling step includes a step of crushing the battery cell with a shredder or a hammer to break down the battery cell into a can case, terminals, resin members, a positive electrode, a negative electrode, and a separator. The dismantling step further includes a step of separating the members into each component by a physical sorting technology such as sieving, airflow sorting, magnetic separation, specific gravity separation, or flotation sorting. With the battery cell dismantling step, a black mass is acquired as an intermediate product.

The acid extracting step is a step of performing acid extraction by using the black mass obtained by the battery cell dismantling step (step S6). The black mass is a general term of mixed materials containing a positive electrode active material, a negative electrode active material, and a composite carbon component. The positive electrode active material contains a ternary cathode material (NCM) or lithium iron phosphate (LPF). The negative electrode active material contains carbon, silica, and the like. The composite carbon component contains an electrically conductive auxiliary agent, a binder, an electrolyte solution component, and the like. In the acid extracting step, the positive electrode active material, iron, aluminum, and copper are all dissolved. For example, the acid extracting step causes all metal components to be dissolved with a strong acid such as a sulfuric acid of 50° C. or more. In the acid extracting step, a carbonate is decomposed.

The filtering and washing step is a step of collecting an undissolved component other than the dissolved matter (step S7). The filtering and washing step is a step of performing solid-liquid separation by filter-pressing or the like and performing water washing. The dissolved matter contains the positive electrode active material, iron, aluminum, and copper. A dissolving solution containing this dissolved matter is a metal dissolved solution and is an acid solution having a small ph value. In the filtering and washing step, for example, a dissolving solution having a ph value of 4 or less is filtered and separated. With the filtering and washing step, a carbon-rich insoluble component (a black mass residue) is acquired as a solid matter.

The mixing step with the crude oil is a step of mixing the black mass residue acquired by the filtering and washing step into crude oil (step S8). In the mixing step, the black mass residue is mixed into a large amount of crude oil. The ratio (blending ratio) of the crude oil and the black mass residue is set to 10:1 or more. In the mixing step, the black mass residue is mixed into the crude oil of an amount that is equal to or larger than ten times the amount of the black mass residue. Moreover, the blending ratio is only required to be 10:1 or more, and may be, for example, 100:1, 1,000:1, or the like. With the blending ratio being set to this magnitude, the influence on the crude oil quality after the mixing becomes an error level. The blending ratio can be controlled in accordance with the composition of the black mass residue.

The crude oil having the black mass residue mixed therein by the mixing step (step S8) becomes a wide variety of products by oil refining. The oil refining includes an atmospheric distillation step of putting the crude oil having the black mass residue mixed therein by the mixing step through an atmospheric distillation device. With the black mass residue alone, it is almost impossible to separate the black mass residue even when the atmospheric distillation is performed, but the mixed reaction with an unspecified number of oily compounds included in the crude oil allows material recycling to be performed. With the black mass residue being mixed into a large amount of crude oil in the mixing step, the black mass residue reacts with the crude oil at the heat of 350° C. or more in the oil refining to be material-recycled into valuables such as various gases, naphtha, gasoline, kerosene, light oil, heavy oil, coke, lubricating oil, and asphalt. The black mass residue is not decomposed even at 350° C., and can be material-recycled to a coke raw material. Most part of the black mass residue is pure carbon components including graphite or acetylene black. An electrolyte solution component, carboxymethyl cellulose (CMC), styrene butadiene rubber (SBR), polyvinylidene fluoride (PVDF), a separator, an insulating resin piece, and the like that are small-amount components included in the black mass residue are thermally decomposed in the process of heating in the oil refining.

Further, the method of recycling the battery in the embodiment can be divided into a battery dismantling step (step SA), a black mass residue refining step (step SB), and a mixing step of the black mass residue and the crude oil (step SC).

The battery dismantling step (step SA) is a step from the detoxifying step (step S1) to the battery cell dismantling step (step S5). The black mass residue refining step (step SB) is a step from the acid extracting step (step S6) to the filtering and washing step (step S7). The mixing step of the black mass residue and the crude oil (step SC) is the mixing step with crude oil (step S8).

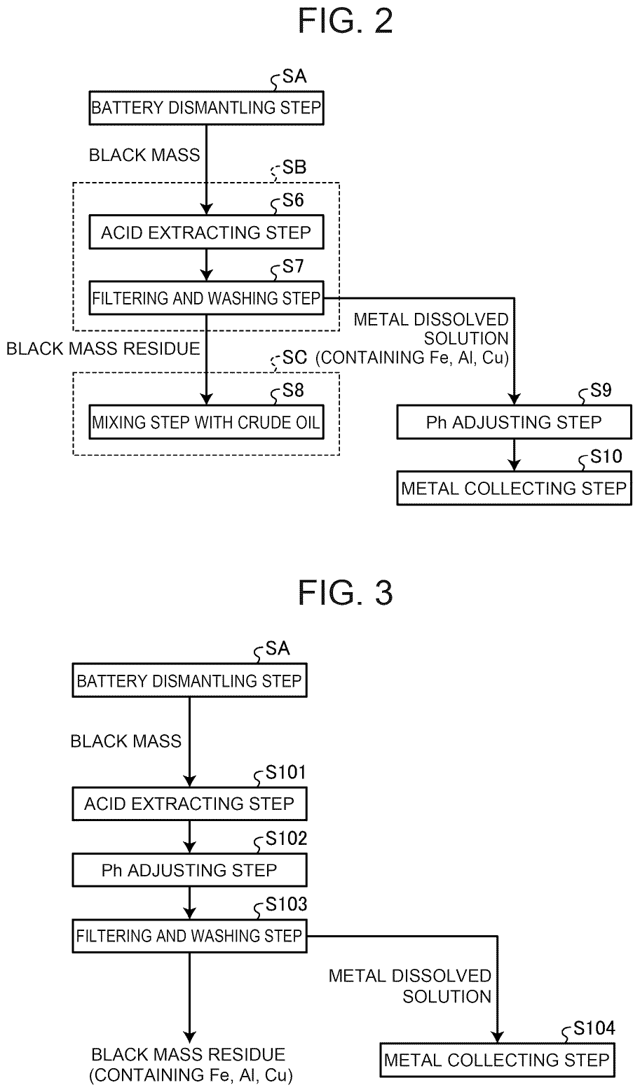

As illustrated in FIG. 1 and FIG. 2, a black mass is obtained as an intermediate product by the battery dismantling step. The electrolyte solution collecting step (step S4) in the battery dismantling step is a non-roasting step, and hence the black mass obtained by the battery cell dismantling step (step S5) thereafter has a post-non-roasting treatment composition. This black mass contains a positive electrode active material, a negative electrode active material, a positive or negative auxiliary agent, an electrolyte solution (uncollected part), a separator piece, an insulating resin piece, iron, aluminum, and copper.

As illustrated in FIG. 2, in the black mass residue refining step (step SB), the black mass residue is refined by using the black mass obtained by the battery dismantling step (step SA). In this refining step, the filtering and washing step (step S7) is performed by using the dissolving solution and the undissolved component obtained by the acid extracting step (step S6). In this refining step, the ph is not adjusted between the acid extracting step (step S6) and the filtering and washing step (step S7). That is, the method of recycling the battery in the embodiment does not include a step of adjusting the ph before the filtering and washing step.

As illustrated in FIG. 3, in a recycling method of a comparative example, a ph adjusting step (step S102) is performed after an acid extracting step (step S101), and a filtering and washing step (step S103) is performed after the ph adjusting step. The recycling method of the comparative example is a method of recycling rare metals from the lithium-ion battery.

In the recycling method of the comparative example, after the acid treatment and before the filtering and washing, unnecessary metals are re-precipitated by crude neutralization by the ph adjusting step (step S102), and a black mass residue having the unnecessary metals mixed therein is obtained by the filtering and washing step (step S103). In the ph adjusting step (step S102), unnecessary metals that can be removed in the subsequent refining step are subjected to ph adjustment by sodium hydroxide or the like, and thus metals such as iron, aluminum, and copper are precipitated. Although the black mass residue obtained by the filtering and washing step (step S103) includes unnecessary metals such as iron, aluminum, and copper, the black mass residue is processed as waste, and hence there is no problem even when the black mass residue contains the unnecessary metals. The reasons why the black mass residue is treated as waste are because the black mass residue is a composite of carbon components, and a great cost is required to separate the composite into single carbons, and because the black mass residue does not have uniform physical properties because of being exposed to various environments such as roasting and crushing before the acid extraction. Moreover, the low value metals precipitated in the ph adjusting step (step S102) are also discharged while being mixed in the black mass residue, and hence this causes difficulty in carbon use. As in the comparative example, most of carbon-rich insoluble components (black mass residue) that are not eluted by acid extraction or the like are processed as waste, and are burned without being material-recycled. Further, a metal collecting step (step S104) is performed by using a metal dissolved solution obtained by the filtering and washing step (step S103). In the metal collecting step, metals are collected by extraction-electrolytic refining or the like.

As in the recycling method of the comparative example, in most cases, after the acid treatment and before the filtering and washing, the unnecessary metals are re-precipitated by crude neutralization and mixed with the black mass residue.

In contrast, in the method of recycling the battery in the embodiment, as illustrated in FIG. 2, neutralization is not performed purposely after the acid treatment, and solid-liquid separation is performed by filtering and washing. In the filtering and washing step (step S7), filtering is performed without change from a low-ph acid solution not subjected to ph adjustment, but the ph is gradually raised to a neutralization area by water washing. Accordingly, the black mass residue becomes a safe substance that is not acidic. With the filtering and washing step (step S7), a black mass residue that is increased in carbon composition and does not include unnecessary metals can be obtained. With the use of this black mass residue, the black mass residue can be mixed into the crude oil in the mixing step with the crude oil (step S8). The method of recycling the battery in the embodiment performs filtering before metal precipitation for the purpose of removing metal components not included in the crude oil, thereby being capable of reducing the amount of metal mixed in the black mass residue.

The black mass residue is fine particles of several micrometers to several tens of micrometers, and hence sufficient dispersion and fluidity can be ensured when the black mass residue and the crude oil are mixed. Thus, the black mass residue does not hinder oil refining. For example, a black mass residue before mixing into the crude oil is a wet cake. Further, mineral resources are overwhelmingly larger in amount, and, even when the black mass residue has a composition shift, water content, or the like, this can be treated in a range of error. The ratio between the crude oil and the black mass residue is 10:1 or more, and hence the black mass residue is acceptable in the oil refining even without strictly removing the water content or the metal components of the black mass residue. Accordingly, a black mass residue having a wide allowable range and being applicable to mixing into the crude oil is obtained. Further, with the metal components and the like being removed, a calorific value as a raw material can be improved.

The metal dissolved solution obtained by the filtering and washing step (step S7) is neutralized by a ph adjusting step (step S9). The metal dissolved solution obtained by the filtering and washing step (step S7) is a solution in which unnecessary metals are dissolved. In the ph adjusting step, neutralization is performed by water washing. After the ph adjusting step, a metal collecting step is performed (step S10). In the metal collecting step, metals are collected by extraction-electrolytic refining or the like.

As described above, with the embodiment, the black mass residue out of the components of the lithium-ion battery is material-recycled, and hence the recycling efficiency of the battery is improved. From thermal recycling at the time of subjecting the black mass residue to heat treatment as waste, the black mass residue can be reborn as a petroleum product to be material-recycled.

Further, an object that has been industrial waste in the recycling method of the comparative example can be treated as valuables in the recycling method of the embodiment, and hence the transportation cost can be reduced without legal and regulatory constraints. With the black mass residue being treated not as industrial waste but as valuables, transportation by an industrial waste company is unnecessary, and general transportation or consolidated transportation is allowed. Thus, the transportation cost can be reduced.

Further, the black mass residue that has conventionally been treated as industrial waste can be material-recycled. Thus, the industrial waste can be reduced in volume to become iron, aluminum, copper, and the like, and the industrial waste volume can be reduced.

Further, in the oil refining, an existing crude oil refining plant can be used as it is without repairing the plant. Accordingly, the black mass residue can be recycled without the need of initial investment or the like.

Further, the black mass residue costs less than crude oil, and hence, even on the oil refining side, a raw material (a black mass residue) that costs less than crude oil can be used, and the black mass residue can be used without changing the existing process. Accordingly, the usefulness is high.

Further, it is preferable to mix the black mass residue into naphthene-base crude oil, intermediate-base crude oil, or the like that contains pitches (carbon solids). The cost can be reduced due to reduction in use amount of crude oil.

It is to be noted that, in the battery dismantling step (step SA), a roasting step may be carried out in place of the electrolyte solution collecting step (step S4). The roasting step is roasting-type pretreatment, and is a step of achieving detoxification through oxidation. In this case, the black mass obtained by the battery cell dismantling step (step S5) after the roasting step in the battery dismantling step has a post-roasting treatment composition. This black mass contains a positive electrode active material roasting residue, a negative electrode active material roasting residue, a positive or negative auxiliary agent roasting residue, an electrolyte solution roasting residue, a separator roasting residue, an insulating resin roasting residue, iron, aluminum, and copper. In short, in the method of recycling the battery, any residue can be used as long as the black mass is used regardless of roasting or non-roasting. Accordingly, the versatility is high.

What is claimed is:

1. A method of recycling a battery, the method comprising:
performing acid extraction by using a black mass obtained after the battery is dismantled;
performing filtering and washing, the filtering including filtering a dissolved matter and an undissolved component obtained by the acid extraction; and
mixing a black mass residue that is an insoluble component obtained by the filtering and washing into crude oil,
wherein the method does not include adjusting a ph before the filtering and washing.

2. The method according to claim 1, wherein the mixing includes mixing the black mass residue into the crude oil of an amount that is equal to or larger than ten times an amount of the black mass residue.
